(19) United States
(12) Patent Application Publication
(10) Pub. No.: US 2005/0102261 A1
(43) Pub. Date: May 12, 2005

(54) Method, apparatus and computer program for verifying the order of a queue of work items

(75) Inventor: Stephen J. Todd, Winchester (GB)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/920,085

(22) Filed: Aug. 17, 2004

(30) Foreign Application Priority Data
Aug. 19, 2003 (GB) 0319405.7

(51) Int. Cl. G06F 7/00

(52) U.S. Cl. 707/1

(57) ABSTRACT

There is provided a method for verifying the order of a queue of work items (each having a sequence number) in a queuing system having a plurality of processing threads for processing work items on the queue and a browser thread for browsing work items on the queue. The sequence number of a work item which has been processed and has the highest sequence number of all processed work items is determined. This is then recorded in memory (highest processed sequence number). The last work item browsed by a browser thread is also determined and its sequence number is recorded in memory. The recorded highest processed sequence number and the recorded last browsed sequence number are for use in determining where to commence order verification of the queue upon restart.

### RELATED APPLICATIONS

This application claims foreign priority benefits under 35 U.S.C. § 119 to United Kingdom Application Number 0319405.7, filed Aug. 19, 2003, which is herein incorporated by reference in its entirety.

### FIELD OF THE INVENTION

The invention relates to the processing of work items in a queuing system and more particularly to the verification of correct work item ordering.

### BACKGROUND

Certain applications consist of two processes: a work item producer and work item consumer. A queue of work items flows from producer to consumer. It is typically required that the consumer processes these work items in precisely the order they are produced by the producer.

The work items may be represented as messages in a queue. There may be a single work item in each message or multiple work items may be batched by the producer into a single message and consumed by the consumer processes as a single (large) work item.

Queuing systems such as IBM's WebSphere(R) MQ can generally assure that no work items (messages) will be lost or delivered out of order. However, there are exceptional cases where ordering may be interrupted or messages misrouted. Examples include (a) messages sent to a dead letter queue and (b) alternate channel routing invoked.

For this reason it is sometimes worth the producing application allocating each produced message with a sequence number and the consuming application verifying that the messages arrive in order and with no gaps in the sequence number. (Note, even in the case of batching, the single (large) work message can typically be identified by a sequence number.) Where both producer and consumer are single threaded this is fairly straightforward, with some care being needed to make sure that sequence number for the last emitted/consumed message is transactionally hardened to a log (for use in the event of restart—orderly or otherwise). This hardening may, for example, be achieved from the application for example by writing the sequence information to a persistent message in a ‘side’ queue; as is done in certain WebSphere MQ ‘movers’. It is often possible to ‘piggyback’ this sequence information on other information that needs to be hardened (for example, this will happen if a side queue message is written in the same transaction that reads the main queue). This limits the performance impact.

In some cases however the consumer is not single-threaded. Instead, it consists of a single-threaded (non-transactional) ‘master’ browser that examines incoming messages and dispatches them for processing to ‘slave’ (transactional) worker threads (processing threads). The browser performs analysis of the incoming messages to determine (application dependent) possible valid parallelisations—i.e. some application dependent out of order processing may be acceptable. Thus a single browser thread may drive multiple worker threads without breaking the ordering requirements and the worker threads may consume messages in an order that is adequate for the application but does not exactly match the original sequence. This leaves (temporary and correct) holes in the sequence of work items on the queue.

The problem is how to combine order verification with this controlled parallel execution. It is necessary to ensure that order verification is not misled by the holes left by parallel execution; and achieve the combination so that it executes efficiently and works robustly over restarts, whether after controlled shutdown or after system failure.

### SUMMARY

Thus according to one aspect the invention provides a method for verifying the order of a queue of work items in a queuing system, the queuing system having a plurality of processing threads for processing work items on the queue and a browser thread for browsing work items on the queue, wherein each work item has a sequence number and the method comprises the steps of: determining the sequence number of a work item which has been processed and has the highest sequence number of all work items that have been processed (highest processed sequence number); recording in memory the highest processed sequence number; determining the last work item browsed by a browser thread; recording in memory the sequence number of the last browsed work item; and using the recorded highest processed sequence number and the recorded last browsed sequence number in determining where to commence order verification of the queue upon restart.

When the system is functioning normally the browser thread is able to keep track of the work items it has browsed and can detect any missing work items (e.g. via non sequential sequence numbers). A problem occurs however when the browser thread has to commence browsing of the queue again (e.g. as a result of a system failure leading to a recovery process having to recover the queue to the state that it was in prior to the failure or as a result of restart after an orderly shutdown). If it were to start order verification of work items from the very beginning of the queue, then the browser thread is likely to detect missing work items which should not cause an error to be returned—i.e. those work items which have been processed (and thus removed from the queue) out of order due to valid parallelism. If on the other hand the browser thread were to start order verification of the queue too far ahead of the previous point reached, then the browser thread may not detect real errors. By using the last browsed sequence number and the highest processed sequence number, the browsing thread is preferably able to commence order verification of the work items on the queue at an appropriate point which should not return unnecessary errors regarding missing work items. This point could be anywhere within the range defined by the two recorded sequence numbers. This point could even be the highest processed sequence number or the last browsed sequence number.

Preferably a commencement sequence number is recorded in memory and this sequence number falls within the range of the highest processed sequence number and the last browsed sequence number. Preferably order verification is commenced from this point upon restart.

Preferably at restart, the browser thread will be performing two operations: (1) reading and scheduling work items, and (2) queue order verification. Reading and scheduling should preferably restart at the front of the queue. Order verification should preferably not restart till a work item with a sequence number falling within the range described is reached (e.g. the recorded commencement point). It may be that these operations are performed by separate threads.

It is safe to start browsing work items having a sequence number anywhere within the range described above—Browse to the left of this range and there is the chance that exceptions will be thrown in error (due to already processed work items), browse to the right of this range and it is possible that truly invalid gaps in the sequence number of the work items will be missed.

Preferably the highest processed sequence number is updated as a result of a work item with a higher sequence number being processed and the last browsed sequence number is updated as a result of a work item with a higher sequence number being browsed.

In one embodiment, responsive to determining that the highest processed work item has the same sequence number as the recorded commencement sequence number, the recorded commencement sequence number is updated to equal the last browsed sequence number.

In another embodiment, responsive to determining that the highest processed work item has a higher sequence number than the recorded commencement sequence number, the recorded commencement sequence number is updated to equal the last browsed sequence number.

Preferably the recorded commencement sequence number is recorded in non-volatile memory.

Thus by only updating the commencement sequence number when the commencement point equals or is overtaken by the highest processed work item sequence number, unnecessary (and expensive) writes to non-volatile memory are avoided.

According to another aspect, the invention provides an apparatus for verifying the order of a queue of work items in a queuing system, the queuing system having a plurality of processing threads for processing work items on the queue and a browser thread for browsing work items on the queue, wherein each work item has a sequence number and the apparatus comprises: means for determining the sequence number of a work item which has been processed and has the highest sequence number of all work items that have been processed (highest processed sequence number); means for recording in memory the highest processed sequence number; means for determining the last work item browsed by a browser thread; means for recording in memory the sequence number of the last browsed work item; and means for using the recorded highest processed sequence number and the recorded last browsed sequence number in determining where to commence order verification of the queue upon restart.

Note, the invention may be implemented in computer software.

Note, the work items may be represented as messages in the queue. There may be a single work item in each message or multiple work items may be batched by a message producer into a single message and consumed by a consumer processes as a single (large) work item. Note, even in the case of batching the single (large) work item is preferably identifiable via a sequence number.

Note, the queueing system may be a messaging system.

### BRIEF DESCRIPTION OF THE DRAWINGS

A preferred embodiment of the present invention will now be described, by way of example only, and with reference to the following drawings:

FIG. 1 shows a typical state of a queue of work items in accordance with the prior art;

FIG. 2 illustrates the processing of the present invention in accordance with a preferred embodiment; and

FIG. 3 exemplifies the effect of the processing described with reference to FIG. 2.

### DETAILED DESCRIPTION

As discussed above, it is often important to be able to verify incoming work item (e.g. message) order in a queuing (e.g. messaging system) and to assist in this each message is typically allocated a sequence number.

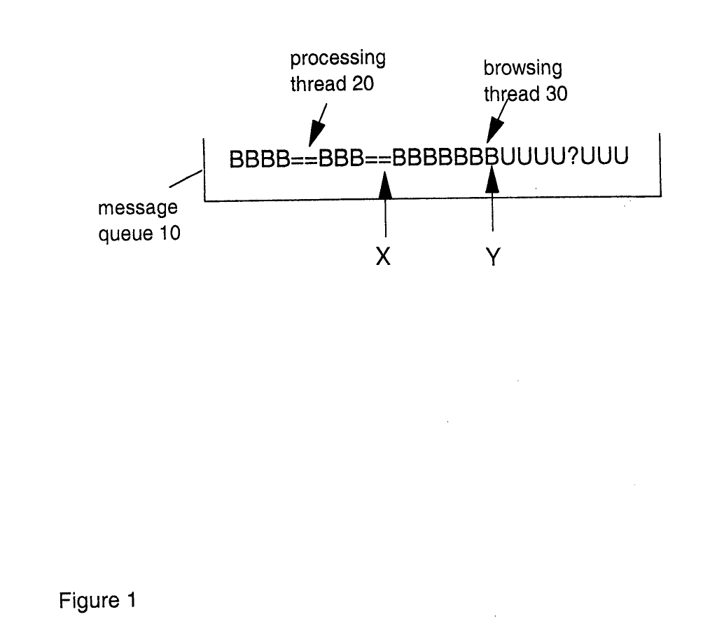

At any point in time, the incoming (input) queue of messages in a messaging system (read from left to right) may look as shown in FIG. 1. Message queue 10 contains some browsed (but not processed) messages B; and some unbrowsed (unread) messages U. A single browser thread 30 browses and thus determines which messages can be processed out of order. Based on its analysis, it drives a plurality of processing threads (one shown 20). These processing threads remove and process messages from the queue (shown as =). Processed messages appear as gaps in the sequence number. These gaps are however “valid” gaps. Occasionally however other “non-valid” gaps appear in the sequence number (represented as ?). As mentioned above these could occur, for example due, to a misrouted message.

Whilst the messaging system is functioning normally there shouldn't be a problem. The browser thread 30 will keep track of which messages it has browsed and can detect invalid gaps in the queue (in terms of missing sequence numbers).

In FIG. 1 the browser thread has reached the point marked Y and is thus happy that there are no ‘missing messages’ prior to this point (otherwise these would have been detected).

The problem occurs on system restart (e.g. after the queue 10 has been recovered to the state it was in prior to the point of system shutdown or failure). On restart, the browser thread will rebrowse the messages marked B, and then browse the messages marked U (unbrowsed). Breaks in the sequence up to point X are valid (they are caused by already processed=messages). However, gaps in the U section (marked ?) are invalid. Therefore, on restart, the browser must not police (verify the order of) messages before X, but must police messages after Y. Note, whilst the browser thread should not verify the order of messages before X, the browser thread will be reanalysing such already browsed messages to determine valid out of order processing.

One option is for the browser thread to remember the last message it browsed (by hardening that message's sequence number to the log). However, this is an expensive solution which would cause a large number of extra units of work. The browser thread would be forced to wait in each case until the appropriate recovery information has been recorded in the log. The browse work is not otherwise transactional and thus such a solution is costly in terms of disk space and processing time.

Thus the preferred embodiment provides a solution to the problem of how to harden sequence information efficiently to allow for failures as well as for controlled shutdown.

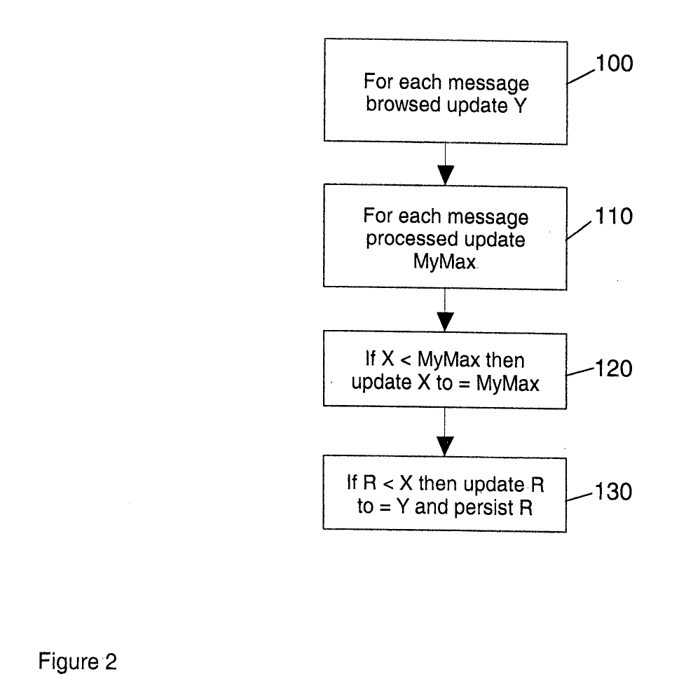

FIG. 2 shows the processing of the present invention in accordance with a preferred embodiment and should be read in conjunction with FIG. 1.

The last known safe sequence number (storedR—see below) from which the browser thread should start browsing on recovery is stored in a log. Getting storedR into the log can be achieved in a number of ways. For example a persistent message holding the value of storedR could be placed on a message queue. The queuing system would thus automatically persist this message to the log. In a queuing system working in conjunction with a database (e.g. work items in a queue represent changes to be made to the database), the storedR value could be put (via e.g. SQL UPDATE) to a database record. In this instance the database system controlling the database will automatically persist the record to its log.

Upon restart the storedR value is recovered into a variable held in memory R. R must be between the points X and Y (inclusive). If R were before X the browser thread might incorrectly diagnose an ‘=’ message as missing rather than a processed message. If R were after Y, it is possible (dependent on how far after point Y, the browser thread begins) that ‘genuinely’ missing messages in the U segment might not be noticed.

Thus as alluded to above, three sequence numbers are kept in volatile memory (not hardened to non-volatile memory) for each input queue: seq# X, seq# Y and seq# R. One sequence number is also held myMax# for each processing thread.

Each time the browser browses a correctly sequenced message, it updates seq# Y (step 100). Each processing thread keeps track, via myMax, of the largest sequence number that it has processed (step 110). Each time a processing thread is about to commit (or finalise) the processing of a message, it performs two operations:
i) determines whether X (representing the message with the highest sequence number that has been processed) is less than its myMax value and if it is then the processing thread updates X to equal that processing thread's myMax value (step 120). In this way X should always represent the sequence number of the highest processed message; and
ii) determines whether sequence number R (representing a safe recovery point) is less than sequence number X and if it is, the processing thread updates R to equal Y and persists R to non-volatile storage into “storedR” (step 130). In this way R should never be allowed to fall too far behind X (and then only temporarily). Alternatively R could be updated when X=R.

Note, the processing thread is not permitted to continue processing until the two operations described above have been completed.

On restart the browser thread recovers the hardened (persisted) sequence number represented by storedR into R. It is also stored into X and Y. The sequence number denoted by R is used in determining the point at which to start verifying message ordering. Thus the browser thread safely ignores gaps up to R by beginning verification from this point. In this way only gaps after R are detected.

Pseudocode executed on restart is:

| | |
|---|---|
| isVerifying = false; | // initially the verifying phase has not been |

// reached - i.e. point R has not been

// reached

| | |
|---|---|
| X, Y, R = storedR; | // initialise X, Y and R to storedR |

Loop till finished

| | |
|---|---|
| ReadMessage | // browse message as per usual |

If isVerifying then

| | |
|---|---|
| Verify | // if verifying phase reached - then verify |

Else

If newMessage.SequenceNumber > R then is Verifying = true

| | |
|---|---|
| End | // once R is reached start verifying |

AnalyseAndDispatchMessage // decide whether message can be

// processed out of order - whether

// or not verifying

| | |
|---|---|
| End | // loop till finished |

During restart processing, Y will contain the largest message sequence number browsed during this session. X will initially be larger than ‘real’ sequence number of last message processed, but this will not prevent the correct operation of the algorithm.

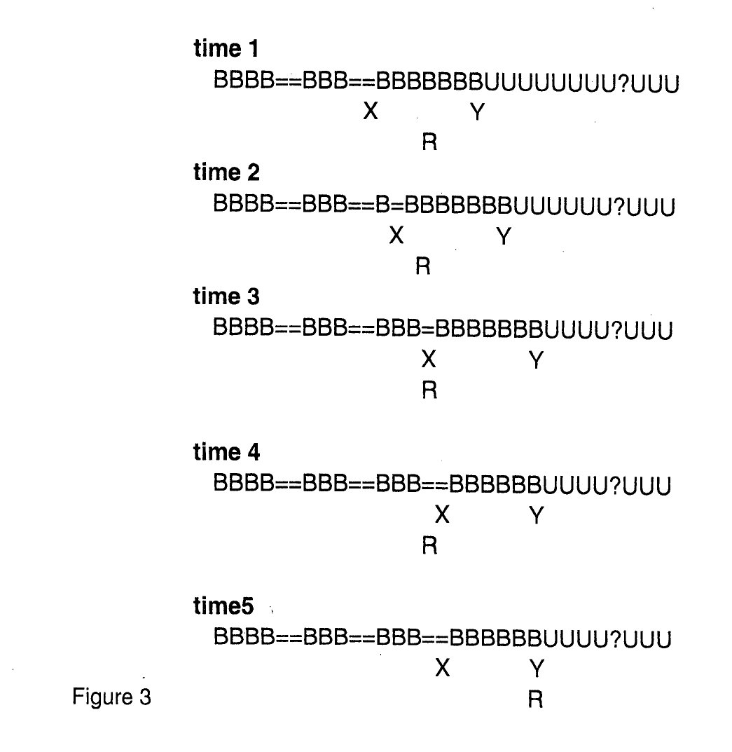

The effect of the algorithm described with reference to FIG. 2 is exemplified by FIG. 3.

At time1, the queue looks as depicted in FIG. 1 with X representing the highest processed message and Y representing the highest browsed message. R is now additionally shown and as previously mentioned represents a safe point from which recovery may be initiated (i.e. R is within the X . . . Y window). Note, time1 is not meant to depict the situation immediately following restart.

At time2, X and Y have advanced as more messages are processed (X) and browsed (Y). There is however no need to update R since R still sits within the X . . . Y window.

At time3 X catches up with R and at time4 X overtakes R. Thus at this point R is moved to equal Y and this value is persisted to the log (time 5). (As alluded to above, R could alternatively be made to equal Y at time3 instead of time4.)

The effect of this is that R will bounce between X and Y as the X . . . Y window advances but will only need to be updated when X overtakes (or equals) R (i.e. less frequently). Thus minimal information is persisted to the log.

It will be appreciated that order verification does not have to start at the point denoted by R—any point within the X . . . Y window (inclusive) is safe.

1. A method for verifying the order of a queue of work items in a queuing system, the queuing system having a plurality of processing threads for processing work items on the queue and a browser thread for browsing work items on the queue, wherein each work item has a sequence number and the method comprises the steps of:
determining the sequence number of a work item which has been processed and has the highest sequence number of all work items that have been processed (highest processed sequence number);
recording in memory the highest processed sequence number;
determining the last work item browsed by a browser thread;
recording in memory the sequence number of the last browsed work item; and
using the recorded highest processed sequence number and the recorded last browsed sequence number in determining where to commence order verification of the queue upon restart.

2. The method of claim 1, wherein the step of using the recorded highest processed sequence number and the recorded last browsed sequence number comprises:
recording a commencement sequence number in memory, the commencement sequence number falling within the range of the highest processed sequence number and the last browsed sequence number; and
commencing order verification from a work item having the commencement sequence number.

3. The method of claim 2, wherein the highest processed sequence number is updated as a result of a work item with a higher sequence number being processed and the last browsed sequence number is updated as a result of a work item with a higher sequence number being browsed, the method comprising the step of:
responsive to determining that the highest processed work item has the same sequence number as the recorded commencement sequence number, updating the recorded commencement sequence number to equal the last browsed sequence number.

4. The method of claim 2, wherein the highest processed sequence number is updated as a result of a work item with a higher sequence number being processed and the last browsed sequence number is updated as a result of a work item with a higher sequence number being browsed, the method comprising the step of:
responsive to determining that the highest processed work item has a higher sequence number than the recorded commencement sequence number, updating the recorded commencement sequence number to equal the last browsed sequence number.

5. The method of claim 3, wherein the commencement sequence number is recorded in non-volatile memory.

6. The method of claim 4, wherein the commencement sequence number is recorded in non-volatile memory.

7. Apparatus for verifying the order of a queue of work items in a queuing system, the queuing system having a plurality of processing threads for processing work items on the queue and a browser thread for browsing work items on the queue, wherein each work item has a sequence number and the apparatus comprises:
means for determining the sequence number of a work item which has been processed and has the highest sequence number of all work items that have been processed (highest processed sequence number);
means for recording in memory the highest processed sequence number;
means for determining the last work item browsed by a browser thread;
means for recording in memory the sequence number of the last browsed work item; and
means for using the recorded highest processed sequence number and the recorded last browsed sequence number in determining where to commence order verification of the queue upon restart.

8. The apparatus of claim 6, wherein the means for using the recorded highest processed sequence number and the recorded last browsed sequence number comprises:
means for recording a commencement sequence number in memory, the commencement sequence number falling within the range of the highest processed sequence number and the last browsed sequence number; and
means for commencing order verification from a work item having the commencement sequence number.

9. The apparatus of claim 7, wherein the highest processed sequence number is updated as a result of a work item with a higher sequence number being processed and the last browsed sequence number is updated as a result of a work item with a higher sequence number being browsed, the apparatus comprising:
means, responsive to determining that the highest processed work item has the same sequence number as the recorded commencement sequence number, for updating the recorded commencement sequence number to equal the last browsed sequence number.

10. The apparatus of claim 7, wherein the highest processed sequence number is updated as a result of a work item with a higher sequence number being processed and the last browsed sequence number is updated as a result of a work item with a higher sequence number being browsed, the apparatus comprising:
means, responsive to determining that the highest processed work item has a higher sequence number than the recorded commencement sequence number, for updating the recorded commencement sequence number to equal the last browsed sequence number.

11. The apparatus of claim 9, wherein the commencement sequence number is recorded in non-volatile memory.

12. The apparatus of claim 10, wherein the commencement sequence number is recorded in non-volatile memory.

13. A computer program product for verifying the order of a queue of work items in a queuing system, the queuing system having a plurality of processing threads for processing work items on the queue and a browser thread for browsing work items on the queue, wherein each work item has a sequence number, the computer program product comprising:
program code adapted to perform the method of claim 1 when said program is run on a computer; and
a computer readable media bearing the program code.

14. The computer program product of claim 13, further comprising program code adapted to perform the method of claim 2 when said program is run on a computer.

15. The computer program product of claim 13, further comprising program code adapted to perform the method of claim 3 when said program is run on a computer.

16. The computer program product of claim 13, further comprising program code adapted to perform the method of claim 4 when said program is run on a computer.

17. The computer program product of claim 13, further comprising program code adapted to perform the method of claim 5 when said program is run on a computer.

18. The computer program product of claim 13, further comprising program code adapted to perform the method of claim 6 when said program is run on a computer.
